(19) United States
(12) Patent Application Publication
(10) Pub. No.: US 2005/0264884 A1
(43) Pub. Date: Dec. 1, 2005

(54) Projection objective for microlithography

(75) Inventors: Christoph Zaczek, Heubach (DE); David Shafer, Fairfield, CT (US); Wilhelm Ulrich, Aalen (DE)

Correspondence Address: SUGHRUE MION, PLLC, 2100 PENNSYLVANIA AVENUE, N.W., SUITE 800, WASHINGTON, DC, 20037, US

(73) Assignee: CARL ZEISS SMT AG

(21) Appl. No.: 11/059,364

(22) Filed: Feb. 17, 2005

Related U.S. Application Data
(60) Provisional application No. 60/544,492, filed on Feb. 17, 2004.

(51) Int. Cl. G02B 5/30

(52) U.S. Cl. 359/487

(57) ABSTRACT

A projection objective (5) for microlithography for projecting a pattern arranged in an object plane (8) of the projection objective (5) has in the light path between the object plane (8) and the image plane (11) at least one beam deflecting device (19) with at least one totally reflective surface (17) that is inclined to an incidence direction of the radiation incident on the totally reflective surface (17) in such a way that substantially all the radiation coming from the object plane (8) and striking the totally reflective surface (17) is totally reflected at the totally reflective surface (17). A high reflectivity in conjunction with high angle of incidence with respect to the surface normal to the totally reflective surface (17) can be achieved with the aid of the beam deflecting device (19). In the case of catadioptric projection objectives, in particular, it is possible thereby to fashion designs that without the use of total reflection for beam deflection can be implemented only with a substantially greater outlay on construction.

The application claims priority from U.S. Provisional Application 60/544,492 filed on Feb. 17, 2004, the disclosure of which is incorporated herein by reference.

### BACKGROUND OF THE INVENTION

1. Field of the Invention

The invention relates to a projection objective for microlithography for projecting a pattern arranged in an object plane of the projection objective into an image plane of the projection objective.

2. Description of the Related Art

Such projection objectives are used in projection exposure machines for fabricating semiconductor components and other finely structured devices, in particular in wafer scanners and wafer steppers. They serve for projecting patterns of photomasks or lined plates, generally referred to below as masks or reticles, onto an article coated with a light-sensitive layer with very high resolution on a demagnified scale.

In order to produce ever finer structures, it is aimed at on the one hand to enlarge the image-side numerical aperture (NA) of the projection objective, and on the other hand to use ever shorter wavelengths, preferably ultraviolet light having wavelengths of less than approximately 260 nm.

Only a few sufficiently transparent materials are still available in this wavelength range for producing the optical components, in particular synthetic silica glass (fused silica) and fluoride crystals, such as calcium fluoride. The Abbe constants of these materials are relatively close together, and so it is difficult to provide purely refractive systems with adequate correction of chromatic aberrations. Such systems also require a great deal of lens material which is available in suitable quality only to a very limited extent.

In view of the difficulties with color correction and the limited availability of suitable lens materials, increasing use is being made of catadioptric systems for very high resolution projection objectives, refractive and reflecting components, that is to say lenses and mirrors, in particular, being combined in such systems. If the aim is to achieve projecting free from obscuration and vignetting, beam deflecting devices that are frequently denoted as beam splitters are required given the use of projecting mirror surfaces. Both systems with geometrical beam splitting, for example with one or more fully reflecting deflecting mirrors, and systems with physical beam splitters, for example polarization beam splitters, are known.

Catadioptric projection objectives with geometrical beam splitting are to be gathered, for example, from EP 1 260 845 (corresponding to US 2003/0021040 A1) or the US patent application bearing Ser. No. 10/166,332 from the applicant. The systems are outstandingly corrected. Examples for catadioptric projection objectives with physical beam splitters are shown in the International patent application WO 03/027747 A1 from the applicant.

A projection system for generating a video image is disclosed in U.S. Pat. No. 4,969,730. It comprises a beam splitter element that is operated to couple illuminating light by reflection into the projection system and by transmission into the projection beam path. The reflection is carried out at a side face of a prism serving as a totally reflective surface, specifically before the light strikes a reflective image generating field serving as object.

If a reflecting surface of a beam deflecting device is struck by a beam at high incidence angles with reference to its surface normal, a substantial portion of the radiation is absorbed or scattered at this surface such that after deflection the intensity of radiation of the beam is substantially reduced and/or nonuniformally distributed over the beam cross section. Even if the reflecting surface is provided with a highly reflecting coating, it is frequently possible to achieve only an inadequate reflectivity in the case of high incidence angles. In addition, in the case of prolonged irradiation with hard UV radiation, the reflection properties of reflective coatings can worsen in the course of time (layer degradation), thus limiting the useful service life.

In addition, during reflection of such a surface, the radiation is generally influenced in a fashion dependent of polarization in such a way that a difference in intensity occurs between a first component of the electric field strength vector, which oscillates perpendicular to the incidence plane (s-polarized light) and a second component, which oscillates parallel to the incidence plane (p-polarized light) (s-p splitting).

### SUMMARY OF THE INVENTION

It is one object of the invention to provide a projection objective having a beam deflecting device where a beam deflecting surface of the beam deflecting device has a high reflectivity for the striking radiation even in the case of prolonged irradiation.

As a solution to this and other objects, this invention, according to one formulation, provides a projection objective for microlithography for projecting a pattern arranged in an object plane of the projection objective into an image plane of the projection objective, wherein there is provided in the light path between the object plane and the image plane at least one beam deflecting device with at least one totally reflective surface that is inclined to an incidence direction of the radiation incident on the totally reflective surface in such a way that substantially all the radiation coming from the object plane and striking the totally reflective surface is totally reflected at the totally reflective surface.

Advantageous developments are specified in the dependent claims. The wording of all the claims is incorporated in the description by reference.

In the case of an inventive projection objective of the type mentioned at the beginning, there is provided in the light path between the object plane and the image plane at least one beam deflecting device with at least one totally reflective surface that is inclined to an incidence direction of the radiation incident on the totally reflective surface in such a way that substantially all the radiation coming from the object plane and striking the totally reflective surface is totally reflected at the totally reflective surface. The totally reflective surface thus serves to fold the light path between object plane and image plane.

Total reflection occurs at an interface between an optically denser medium of reflective index n₁ and an optically thinner medium of reflective index n₂<n₁ when a light beam from the optically denser medium strikes the interface at an incidence angle greater than arc sin(n₂/n₁) with reference to the surface normal to the interface. In this case, no reflective light beam enters the optically thinner medium, but rather the total intensity of the light is reflected at this interface, which is also denoted as totally reflective surface.

The reflectivity of such a totally reflective surface is therefore 100% in the ideal case. However, within the meaning of this application totally reflective surfaces with lower reflectivities of, for example, 90%, 80% or 70% such as possibly occur given media with intrinsic absorption can be useful. In order to achieve an adequately high reflectivity, the totally reflective surface must be aligned with the total striking radiation such that all the rays striking inside the beam essentially have incidence angles that are above the critical angle of total reflection of the totally reflective surface, but below 90°. The beam deflection at the totally reflective surface comes about with the latter having reflective surfaces applied to it, such that no wear phenomena impairing the reflectivity can occur at this surface owing to layer degradation. Again, in the case of media without intrinsic absorption no splitting of the intensities of s- and p-polarized radiation occurs at the totally reflective surface, such as is the case when use is made for beam deflection of reflective layers operated in the vicinity of the Brewster angle. However, in the case of lower intrinsic absorption (absorption coefficient k<0.001), a slight s-p intensity splitting can occur at the totally reflective surface. For media with or without intrinsic absorption, an s-p phase splitting, that is to say a phase shift of the orthogonal polarization directions, can occur at the totally reflective surface.

In a further refinement of the invention, the totally reflective surface is aligned with reference to the marginal rays of a beam incident on the totally reflective surface in such a way that the angles that the marginal rays form at their reflection points with a surface normal to the totally reflective surface are above the critical angle of total reflection of the material in the vicinity of the totally reflective surface. It is thereby possible to achieve that the entire beam including marginal rays is reflected at the totally reflective surface with substantially the same degree of reflexion, and this is required in particular for realizing the finest resolutions. If the centroid ray of a convergent or divergent beam strikes the totally reflective surface obliquely, and if the above condition is fulfilled for the portion of the marginal rays of the beam that form the smallest angle with respect to the surface normal to the totally reflective surface, the condition is generally also fulfilled for all the other rays of the beam. The above condition is likewise to be fulfilled for all the rays of a radiation beam striking in parallel.

In a development of the invention, the beam deflecting device comprises at least one prism with a beam entrance surface, a beam exit surface and at least one totally reflective surface, the beam entrance surface being aligned substantially perpendicular to a beam incidence direction, and/or the beam exit surface being aligned substantially perpendicular to a beam exit direction. A prism within the meaning of this application is a body made from a material transparent to the radiation used and having at least two planes as interfaces. The beam entrance surface and/or the beam exit surface are preferably flat. However, they can also be slightly spherically or aspherically curved, for example for the purposes of correction or compensation. The perpendicular entrance and/or exit of the radiation ensures that the radiation is not reflected, or only slightly so, depending on beam divergence, at the entrance surface and/or the exit surface, an additional beam deflection thereby being avoided at these surfaces.

In a development of the invention, the beam deflecting device consists of CaF₂ at least in the vicinity of the totally reflective surface. The critical angle of total reflection of CaF₂ with air is approximately 39.8° given a wavelength of 157 nm, which is typical for the illuminating radiation of catadioptric projection objectives in microlithography. The totally reflective surface can therefore be operated in a projection objective for angles above this critical angle when the optical components of the objective are surrounded by gas.

In a development of the invention, the beam deflecting device consists of MgF₂ at least in the vicinity of the totally reflective surface. The critical angle of total reflection of MgF₂ with air is approximately 42.5° given a wavelength of 157 nm. Regard must be paid to the birefringence of MgF₂ when this material is used in the beam deflecting device.

In a further refinement of the invention, the projection objective is a catadioptric projection objective in which at least one catadioptric objective part with at least one beam deflecting device and a concave mirror is provided between the image plane and the object plane, and the beam deflecting device has at least one totally reflective surface. A beam deflecting device and a concave mirror are compulsory as constituents of catadioptric objective parts of the projection objectives considered here. Many catadioptric objectives additionally have at least one further beam deflection device such that a multiplicity of folding geometries can be implemented. The beam deflecting devices of such catadioptric objectives can be equipped in each case with a totally reflective surface.

In a development of the invention, a beam deflecting device is positioned in the beam path upstream of the concave mirror, and this beam deflecting device has at least one totally reflective surface. It is thereby ensured that substantially all the radiation coming from the object plane of the projection objective toward the beam deflecting device strikes the concave mirror. It is preferred to fit in the light path downstream of the concave mirror a second beam deflecting device with a beam deflecting surface that is operated at lower incidence angles. As a rule, said surface can produce adequate reflection if it is provided with a highly reflecting reflective coating.

In further refinement of the invention, a beam deflecting device with at least one totally reflective surface is positioned downstream of the concave mirror. The beam deflecting device should be operated for this purpose in a sufficiently high range of incidence angle.

In a development of the invention, a first beam deflecting device is positioned in the beam path upstream of the concave mirror, and a second beam deflecting device is positioned in the beam path downstream of the concave mirror, the first and the second beam deflecting devices having at least one totally reflective surface. Such embodiments are distinguished by particularly low reflection losses and a corresponding high total transmission.

In the case of all embodiments with at least two beam deflecting devices, the two beam deflecting devices can be positioned such that the object plane and the image plane of the projection objective are aligned in parallel. This can be achieved in the case of two beam deflecting devices by a perpendicular alignment of the reflecting surfaces with respect to one another.

In a development of the invention, the totally reflective surface of the beam deflecting device is inclined to the marginal rays of a beam striking the totally reflective surface during operation of the projection objective in such a way that all the marginal rays of the radiation striking the totally reflective surface of the beam deflecting device during operation of the projection objective are incident at an angle of more than approximately 39° with respect to the surface normal to the totally reflective surface. The vicinity of the totally reflective surface can therefore consist of, for example, CaF₂, which has a critical angle of total reflection of approximately 39.8°. The numerical aperture of half the aperture angle of the beam striking the total reflective surface must in this case be set by means of suitable optical elements in the projection objective in such a way that not only the centroid ray of the beam, but also the critical marginal rays strike the total reflective surface above the critical angle of total reflection.

In further refinement of the invention, fitted in the beam path between a totally reflective surface of a first beam deflecting device and a totally reflective surface of a second beam deflecting device is a polarization splitter surface that is designed for transmitting the radiation reflected by the totally reflective surface of the first beam deflecting device, and for reflecting the radiation reflected by the concave mirror. A catadioptric objective of such design permits a parallel alignment of object plane and image plane. With the aid of such a design, however, the concave mirror can be arranged relatively far removed from the object plane of the projection objective without the use of additional optical components, and this is a structural advantage.

In a development of the invention, an object-side part of the optical axis and an image-side part of the optical axis are defined, the image-side part of the optical axis and the object-side part of the optical axis being coaxial. An object-side part of the object axis is defined between the object plane and a first folding of the beam path. An image-side part of the optical axis is defined correspondingly between a last folding of the beam path and the image plane. As in the case of a purely refractive projection objective, no object image shifts occurs with a projection objective for microlithography having a common image-side and object-side part of the optical axis. Consequently, this embodiment of a catadioptric projection objective can be positioned instead of the refractive projection objective in a microlithography projection exposure machine without the need for the reticle holder or of the wafer stage to be reconfigured.

In a development of the invention, the projection objective is a catadioptric projection objective, there being provided between the image plane and the object plane at least one catadioptric objective part with at least one beam deflecting device and a concave mirror, an optical axis defined by the concave mirror of the catadioptric objective part and an object-side optical axis enclosing an angle of more than 105°. The angle can be, for example, 110° or 120° or 130°. A beam deflection close to the object plane is possible owing to the high beam deflection angle, since the concave mirror can be positioned at an adequate distance from the object plane. Moreover, it is thereby possible for the beam deflecting device to be kept small, and thus saving material.

Apart from proceeding from the claims, the preceding and further features also emerge from the description and the drawings. Here, the individual features can be implemented on their own or severally in the form of subcombinations in an embodiment of the invention and in other fields and can constitute advantageous designs and designs inherently capable of protection.

FIG. 1 is a schematic of a microlithography projection exposure machine that is designed as a wafer scanner and comprises a catadioptric projection objective with geometric beam splitting in accordance with an embodiment of the invention;

FIG. 2 is a schematic detail view of the catadioptric objective part of FIG. 1 with a beam deflecting device in accordance with an embodiment of the invention;

FIG. 3 is a schematic detail view of the beam deflection device of FIG. 2 with a divergent beam;

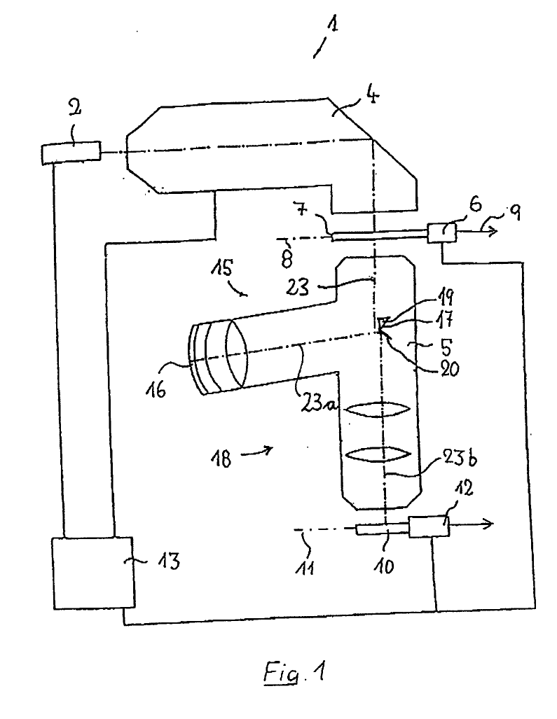

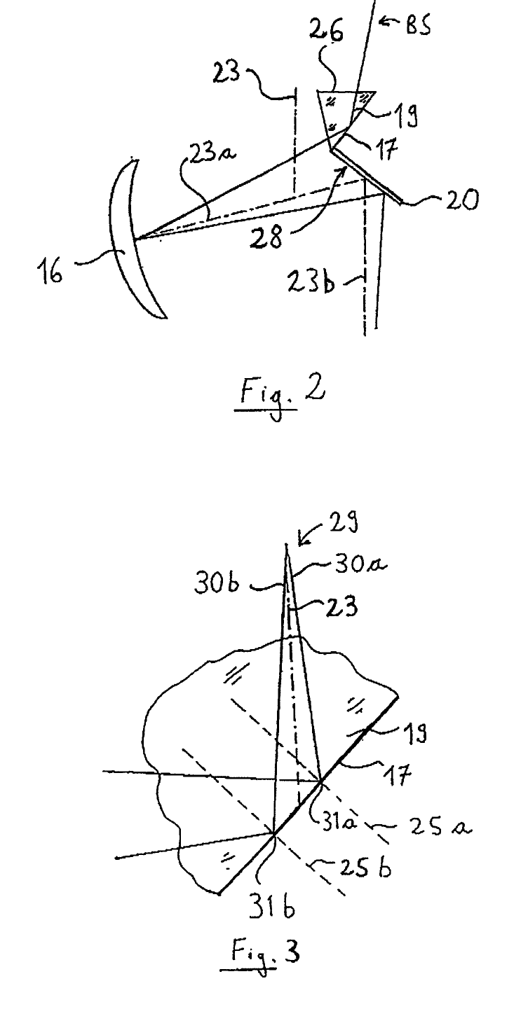

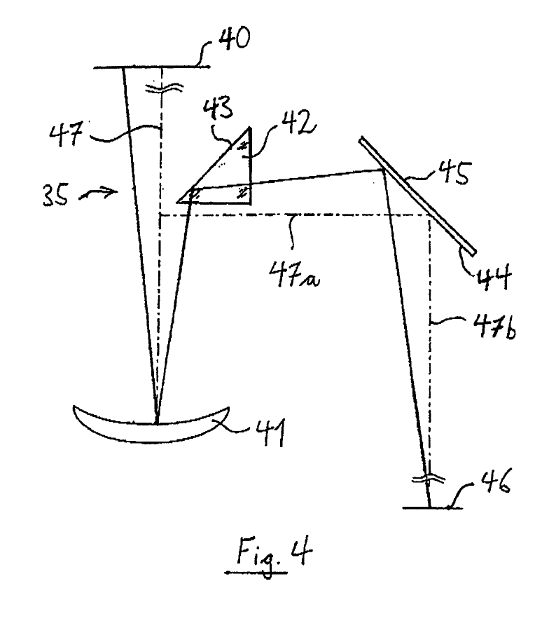

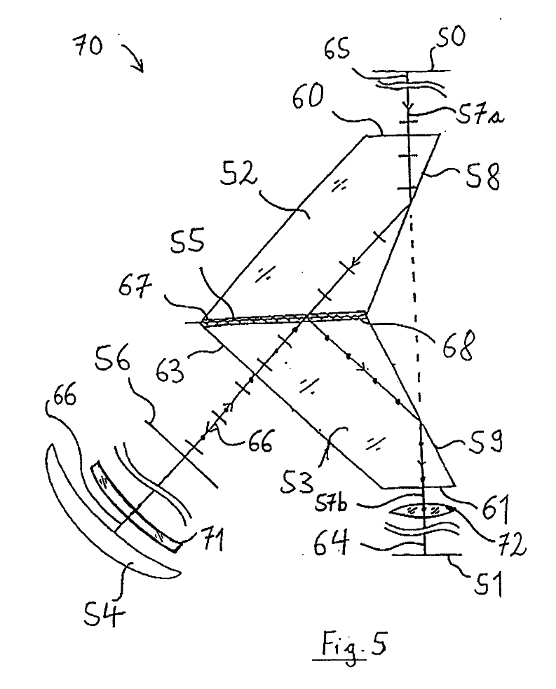

FIG. 4 is a schematic illustration of the catadioptric projection objective with geometric beam splitting in accordance with a further embodiment of the invention;

FIG. 5 is a schematic illustration of a catadioptric projection objective with physical beam splitting in accordance with a further embodiment of the invention.

In the following description of preferred embodiments, the term “optical axis” denotes a straight line or a sequence of straight line segments through the centers of curvature of the optical components. The optical axis is folded at deflecting mirrors or other reflecting surfaces.

A microlithography projection exposure machine in the form of a wafer scanner 1 that is provided for producing semiconductor components of large-scale integration is shown schematically in FIG. 1. The projection exposure machine comprises as light source a laser 2 which emits ultraviolet light with an operating wavelength of 157 nm and which, in the case of other embodiments, can also lie thereabove, for example at 193 nm or 248 nm, or therebelow. A downstream illuminating system 4 generates a large, sharply delimited and homogeneously illuminated image field which is adapted to the telecentricity requirements of the downstream projection objective 5. The illumination system has devices for selecting the illumination mode and can, for example, be switched between conventional illumination with a variable degree of coherence, angular field illumination and dipole or quadrupole illumination. A device 6 for holding and manipulating a mask 7 is arranged behind the illuminating system such that the mask lies in the object plane 8 of the projection objective and, for the purpose of scanner operation, can be moved in this plane in a traversing direction 9 (y-direction) by means of a scan drive.

Following behind the mask plane 8 is the projection objective 5, which acts as reduction objective and projects an image of a pattern arranged on the mask at a reduced scale, for example the scale 1:4 or 1:5, onto a wafer 10 which is coated with a photoresist layer and is arranged in the image plane 11 of the reduction objective. Other reduction scales are possible, for example stronger reductions of down to 1:20 or 1:200. The wafer 10 is held by a device 12 which comprises a scanner drive, in order to move the wafer synchronously with the reticle 7 and parallel to the latter. All the systems are controlled by a control unit 13.

The catadioptric projection objective 5 operates with geometrical beam splitting and has between its object plane (mask plane 8) and its image plane (wafer plane 11) a catadioptric objective part 15 having a first beam deflecting device 19 in the form of a prism 19. The prism 19 has a flat totally reflective surface 17 that is tilted to an object-side part of the optical axis 23 of the projection objective 5 in such a way that the radiation coming from the object plane is deflected virtually completely at the totally reflective surface 17 in the direction of the concave mirror 16, which defines an intermediate part 23a of the optical axis.

In addition to this beam deflecting device 19 required for the functioning of the projection objective, there is provided as second beam deflecting device in the light path downstream of the concave mirror 16 a flat deflecting mirror 20 that is tilted to the optical axis in such a way that the radiation reflected by the concave mirror 16 is deflected by the deflecting mirror 20 in the direction of the image plane 11 to the lenses of the downstream, dioptric objective part 18. The totally reflective surface 17 and the reflecting surface 20 are perpendicular to one another and have parallel tilting axes perpendicular to the optical axis 23.

FIG. 2 is a schematic detailed view of the catadioptric objective part of FIG. 1 with the beam deflecting device 19. The first beam deflecting device 19, constructed as a prism, has an isosceles triangular surface as basic surface and consists of CaF₂. An illuminating radiation BS incident along the object-side part of the optical axis 23 enters the prism 19 in a fashion substantially perpendicular to a first flat surface, serving as light entrance surface 26 and arranged perpendicular to the object-side part of the optical axis 23, is reflected at the totally reflective surface 17 of the prism 19, and leaves the prism 19 in a fashion vertically perpendicular to a second flat surface, arranged perpendicular to the intermediate part 23a of the optical axis and serving as light exit surface 27, in the direction of the concave mirror 16. The object-side part of the optical axis 23 of the projection objective is inclined by approximately 52.5° to the surface normal to the totally reflective surface 17 such that illuminating radiation striking the totally reflective surface in a fashion parallel to the optical axis 23 experiences a deflection by 105° in the direction of the concave mirror 16. The substantially perpendicular passage of the radiation through the light entrance surface 26 and the light exit surface 27 prevents refraction of the radiation at these surfaces to the greatest possible extent.

The totally reflective surface 17 reflects the incident radiation above the critical angle of total reflection which results in arc sin(n₂/n₁)=39.9° or, respectively, in 41.8° for the interface 17 between CaF₂ (refractive index n₁=1.558 for a wavelength of approximately 157 nm, or of n₁=1.501 for approximately 193 nm) and air (refractive index n₂=1.0). Alternatively, the prism 19 can be fabricated, for example, from MgF₂. For a wavelength of approximately 157 nm, the refractive index of MgF₂ is n₁=1.466, and so the critical angle of total reflection at the interface 17 has a value of 43.0°.

For a wavelength of approximately 193 nm, it is also possible to use SiO₂ as prism material. This means there is no need to distinguish between monocrystalline, birefringent silicon oxide, fused silica and synthetically fabricated silicon (synthetic silica glass) having no birefringence. The former has a refractive index of n₁=1.66 (ordinary ray) for a wavelength of 193 nm, and thus an angle of total reflection of 37.0°, while the latter has a refractive index of n₁=1.56 and an angle of total reflection of 39.9°. The selection of the prism material thus permits control of the angle of total reflection.

The projection objective 5 is configured in such a way that the totally reflective surface 17 is struck by illuminating radiation within a range of incidence angle of 40° to 65°, and so the condition of exceeding the critical angle of total reflection for all rays of the incident beam is fulfilled. The centroid ray angle of the beam is 52.5°, and half the aperture angle of the incident beam is at most 12.5°.

From the light exit surface 27, the illuminating radiation falls onto the concave mirror 16, is reflected thereby and strikes a reflecting surface 28 of the deflecting mirror 20, at which this is deflected in a direction of the image plane 11 along an image-side part 23b of the optical axis of the projection objection. The reflecting surface 28 of the deflecting mirror 20 is operated in a range of incidence angle of approximately 29° to approximately 49°. The incidence angles at the deflecting mirror 20 serving as second beam deflecting device are so small that this device can be coated with a reflective coating that is highly reflecting in the entire range of incidence angle.

A highly reflecting coating in the form of a dielectrically reinforced metal mirror is applied to the reflecting surface 28. The concave mirror surface is, by contrast, of purely dielectric configuration, since this is not operated in a high range of incidence angle. By contrast, the light entrance surface 26 and the light exit surface 27 of the prism 19 have anti-reflection coatings.

FIG. 3 shows a schematic detail view of the beam deflecting device 19 in FIG. 2 with a divergent beam 29 whose half aperture angle is approximately 12.5°, but is depicted roughly half as large in FIG. 3 in order to simplify the illustration. The centroid ray of the beam 29 runs upstream of the beam deflection on the totally reflective surface 17 along the optical axis 23 of the projection objective 5. At a first and a second reflecting point 31a, 31b, two marginal rays 30a, 30b of the beam 29 strike the totally reflective surface 17, specifically with respect to the surface normal 31a, 31b at an angle of approximately 65° for the first marginal ray 30a, and at angle of approximately 40° for the second marginal ray 30b. The critical first marginal ray 30a therefore strikes the totally reflective surface 17 at an angle with respect to the surface normal 31a that is greater than the critical angle of total reflection of 39.8°. The entire radiation including the two marginal rays 30a, 30b is therefore totally reflected at the totally reflective surface 17 and runs divergently further in the direction of the concave mirror 16. The incident beam 29 therefore fulfils the condition that substantially the entire radiation incident on the totally reflective surface is totally reflective there at. In the case of a convergent beam path, the second marginal ray would be the critical ray of fulfilling the condition of total reflection.

It can prove to be favorable for total reflection when the beam coming from the object plane 8 has a small numerical aperture. It can therefore be indicated to position optical elements of positive refractive power between the object plane 8 and the first beam deflecting device 19.

FIG. 4 shows by way of example a schematic illustration of a folding geometry, also denoted as h-geometry, of a catadioptric projection objective with geometrical beam splitting which is distinguished by the use of an inventive beam deflecting device of high reflectivity in conjunction with a high incidence angle. Following the direction of the beam path, the projection objective 35 has an object plane 40, which defines an object-side path 47 of the optical axis, a concave mirror 41 and, downstream thereof, a first beam deflecting device 42. The latter is configured as a prism with a right-angled, isosceles triangular surface as basic surface. It has a hypotenuse surface 43 that serves as first totally reflective surface. A second beam deflecting device 44 is arranged in the light path downstream of the first beam deflecting device 42 and has a reflecting surface that reflects the radiation onto an object plane 46 downstream in the light path. The schematically shown principal ray of the projection runs from the object plane 40 via the concave mirror 41 to the first totally reflective surface 43, is deflected thereat by approximately 100° and strikes the reflective surface 45, from where it is likewise deflected by approximately 100° and runs further in a direction of the image plane 46. The short surfaces of the prism 42, which serve as beam entrance surface and beam exit surface, are struck virtually perpendicularly by the radiation passing through such that it is possible largely to avoid beam refraction at these surfaces. The design shown in FIG. 4 permits a parallel alignment of the object plane 40 and image plane 46 of the projection objective 35.

FIG. 5 is a schematic illustration of a catadioptric projection objective with physical beam splitting in accordance with a further embodiment of the invention. Following the beam path, the projection objective 70 has an object plane 50 and a first beam deflecting device 52 with a first totally reflective surface 58. The beam deflecting device 52 is configured as a prism with a polygonal basic surface, and consists of CaF₂. A first and a second flat side 60, 67 of the prism 52 are opposite one another in parallel and are aligned parallel to the object plane 50 and an image plane 51 of the projection objective 70. The totally reflective surface 58 forms a side of the prism 52 that cuts an object-side part 57a of the optical axis of the projection objective 70 and is inclined to the latter by approximately 67.5° (with respect to the surface normal).

A λ/4 plate 56 and at least one negative lens 71 are positioned upstream of a concave mirror 54 in the light path downstream of the beam deflecting device 52 along an optical axis 66 of the catadioptric objective part. A second beam deflecting device 53 with a second totally reflective surface 59 is positioned downstream thereof in the light path. The second beam deflecting device 53 has a prismatic structure identical to the first beam deflecting device 52, and likewise consists of CaF₂. It likewise has a first and a second side 68, 61 which are opposite one another in parallel and aligned parallel to the object plane 50 and the image plane 51 of the projection objective 70. The totally reflective surface 59 forms a side of the prism 53 that cuts or folds an image-side part of the optical axis 57b of the projection objective 70. A number of lenses, symbolized by a the fact that the first and the second beam deflecting device 52, 53 are of identical design, and so the two beam deflecting devices can be formed by producing one design.

The large angle of deflection of approximately 135° at the first totally reflective surface 58 enables the concave mirror 54 to be positioned far from the object plane 50 in conjunction with beam deflection in the vicinity of the object plane 50. Moreover, owing to the large angle of inclination of 67.5° of the surface normal to the totally reflective surface 58 with respect to the optical axis 57, it is also possible for a beam of high numerical aperture with a half aperture angle of theoretically up to 22.5° also to be completely totally reflected.

The arrangement shown in FIG. 5 is only an example of an advantageous embodiment of the projection objective according to the invention. It goes without saying that the use of large angles of deflection in beam deflecting devices of projection objectives in conjunction with high reflectivity can also have an advantageous effect in many other embodiments not depicted here even in the case of long lasting UV irradiation.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all changes and modifications as fall within the spirit and scope of the invention, as defined by the appendend claims, and equivalents thereof.

positive lens 72, are positioned in the light path between the second beam deflecting device 53 and the image plane 51.

The second side 67 of the first beam deflecting device 52, and the first side 68 of the second beam deflecting device 53 abutt one another at a polarization splitter surface 55. The two prisms 52, 53 are arranged with mirror symmetry relative to the polarization splitter surface 55. The polarization splitter surface 55 is configured such that substantially no light loss can occur during transmission of radiation from the first prism 52 into the second prisms 53. The polarization splitter surface 55 is formed by a dielectric layer system in the case of which a number of individual layers at high and low refractive index alternate with one another.

The object plane 50 and the image plane 51 are arranged in parallel. An object-side optical axis 65 and an image-side optical axis 64 of the projection objective are coaxial. Possibly, as in the case of a conventional purely refractive projection objective, no beam shift (OIS object image shift) occurs with this embodiment of the projection objective.

During operation of the projection objective 70, linearly polarized radiation is irradiated from the object plane 50 into the projection objective 70 along the optical axis 57. The direction of polarization of this radiation is parallel to the incidence plane onto the first totally reflective surface 58 (p-polarization). It strikes perpendicularly an entrance surface 60 of the first prism 52 such that a refraction at this surface is largely avoided. In the interior of the prism, the radiation strikes the totally reflective surface 58, at which it is deflected at a high angle of approximately 135° in the direction of the optical axis 56 of the catadioptric objective path. The radiation runs further along the optical axis 66, in this space traversing the beam splitter surface 55 by transmission and leaving the second prism 53 in a fashion perpendicular to a side 63 thereof. The radiation passes through the λ/4 plate 56 and runs from there further to the concave mirror 54 at which it is reflected such that the λ/4 plate 56 is traversed a second time by it. The two-fold passage through the λ/4 plate 56 effects a phase shift of λ/2 in the electric field strength vector such that the latter is rotated by 90° and is now perpendicular to the plane of incidence onto the polarization splitter surface 55 (s-polarization). After renewed perpendicular passage through the side 63 of the second prism 53, the radiation strikes the polarization splitter surface 55 and, because of the fact that it is now s-polarized, is deflected thereat by approximately 90° in the direction of the second totally reflective surface 59. At the totally reflective surface 59, it is totally reflected a second time at an angle of approximately 135° such that it runs further along the optical axis 57 and leaves the second prism 53 in a fashion perpendicular to a beam exit surface 61. Thereafter, it runs further in the direction of the image plane 51, generating a real intermediate image downstream of the beam deflection device.

An advantage of the arrangement shown in FIG. 5 resides in the fact that the radiation transradiates the prism entrance surfaces 60, 63 and prism exit surfaces 63, 61 virtually perpendicularly such that no refraction occurs at these surfaces. In order to achieve this, the side 63 of the second prism 53 is, in particular, to be aligned substantially perpendicular to the optical axis 66 of the catadioptric objective part. As an option, a positive lens (not illustrated in the drawing) can be inserted into the beam path directly downstream of the object plane 50 in order to achieve a thorough parallelization of the radiation incident on the beam entrance surface 60 of the first prism 52.

A further advantage of the embodiment shown in FIG. 5 is

1. A projection objective for microlithography for projecting a pattern arranged in an object plane of the projection objective into an image plane of the projection objective, comprising:
at least one beam deflecting device provided in the light path between the object plane and the image plane, with at least one totally reflective surface that is inclined to an incidence direction of radiation incident on the totally reflective surface such that substantially all the radiation from the object plane striking the totally reflective surface is totally reflected at the totally reflective surface.

2. The projection objective as claimed in claim 1, wherein the totally reflective surface is aligned with reference to the marginal rays of a beam incident on the totally reflective surface such that angles that the marginal rays form at their reflection points with a surface normal to the totally reflective surface are above a critical angle of total reflection of the material of the beam deflecting device.

3. The projection objective as claimed in claim 1, wherein the beam deflecting device comprises at least one prism with a beam entrance surface, a beam exit surface and at least one totally reflective surface, wherein the beam entrance surface is aligned substantially perpendicular to a beam incidence direction, and the beam exit surface is aligned substantially perpendicular to a beam exit direction.

4. The projection objective as claimed in claim 1, wherein the beam deflecting device consists of CaF₂ at least in the vicinity of the totally reflective surface.

5. The projection objective as claimed in claim 1, wherein the beam deflecting device consists of MgF₂ at least in the vicinity of the totally reflective surface.

6. The projection objective as claimed in claim 1, wherein the projection objective is a catadioptric projection objective, there being provided between the image plane and the object plane at least one catadioptric objective part with at least one beam deflecting device and a concave mirror, the beam deflecting device having at least one totally reflective surface.

7. The projection objective as claimed in claim 6, wherein a beam deflecting device is positioned in the beam path upstream of the concave mirror, and wherein that beam deflecting device has at least one totally reflective surface.

8. The projection objective as claimed in claim 6, wherein a beam deflecting device is positioned in the beam path downstream of the concave mirror, and wherein that beam deflecting device has at least one totally reflective surface.

9. The projection objective as claimed in claim 6, wherein a first beam deflecting device is positioned in the beam path upstream of the concave mirror, and a second beam deflecting device is positioned in the beam path downstream of the concave mirror, and wherein the first beam deflecting device and the second beam deflecting device each have at least one totally reflective surface.

10. The projection objective as claimed in claim 6, wherein a first beam deflecting device is positioned in the beam path downstream of the concave mirror, and a second beam deflecting device is positioned in the beam path downstream of the first deflecting device, the first beam deflecting device and the second beam deflecting device each having at least one totally reflective surface.

11. The projection objective as claimed in claim 1, wherein the totally reflective surface of the beam deflecting device is inclined to all the marginal rays of a beam striking the totally reflective surface during operation of the projection objective such that marginal rays are incident at an angle of more than approximately 39° with respect to the surface normal to the totally reflective surface.

12. The projection objective as claimed in claim 6, wherein fitted in the beam path between a totally reflective surface of a first beam deflecting device and a totally reflective surface of a second beam deflecting device is a polarization splitter surface that is designed for transmitting the radiation reflected by the totally reflective surface of the first beam deflecting device, and for reflecting the radiation retroflected by the concave mirror.

13. The projection objective as claimed in claim 1, wherein an object-side part of the optical axis and an image-side part of the optical axis are defined, the image-side part of the optical axis and the object-side part of the optical axis being coaxial.

14. The projection objective as claimed in claim 1, wherein the projection objective is a catadioptric projection objective, there being provided between the image plane and the object plane at least one catadioptric objective part with at least one beam deflecting device and a concave mirror, an optical axis defined by the concave mirror, of the catadioptric objective part and an object-side optical axis enclosing an angle of more than 105°.

15. A catadioptric projection objective for microlithography for projecting a pattern arranged in an object plane of the projection objective into an image plane of the projection objective comprising:
at least one catadioptric objective part with a concave mirror;
a first beam deflecting device positioned in a beam path upstream of the concave mirror deflecting radiation from the object plane towards the concave mirror and a second beam deflecting device positioned in the beam path downstream of the concave mirror deflecting radiation from the concave morror towards the image plane,
wherein at least one of the first and second beam deflecting device has a totally reflective surface that is inclined to an incidence direction of radiation incident on the totally reflective surface during operation of the projection objective such that marginal rays are incident at an angle of more than approximately 39° with respect to a surface normal to the totally reflective surface, whereby substantially all the radiation from the object plane striking the totally reflective surface is totally reflected at the totally reflective surface.
